(19) United States
(12) Patent Application Publication
(10) Pub. No.: US 2014/0025456 A1
(43) Pub. Date: Jan. 23, 2014

(54) Method of Fundraising Through a Collaborative Creation of Artwork with Prize-Winning Incentives

(71) Applicant: Rosee R. REESE/ROYCE, West Hollywood, CA (US)

(72) Inventor: Rosee R. REESE/ROYCE, West Hollywood, CA (US)

(21) Appl. No.: 13/945,888

(22) Filed: Jul. 18, 2013

Related U.S. Application Data
(60) Provisional application No. 61/673,244, filed on Jul. 18, 2012.

(51) Int. Cl. G06Q 30/02

(52) U.S. Cl. CPC G06Q 30/0279; G06Q 30/0217
USPC 705/14.19

(57) ABSTRACT

Disclosed is a system for providing an artwork and financial based user selection system, enabling creation of a collaborative mosaic work of art. It is robust and easy to use to meet the demands of multiple users and hosts as well as high volumes and quantities of images and monetary contribution. The subject matter of the completed mosaic is actually a mystery initially and is not revealed until the last of the donations/uploads required to complete the picture have been assembled.

The current application claims a priority to the U.S. Provisional Patent application Ser. No. 61/673,244 filed on Jul. 18, 2012.

### FIELD OF THE INVENTION

The present invention relates generally to a software application used to create a collaborative painting or mosaic. More particularly, the present invention is directed to a method and a system of digitally selecting colors from photographs, uploaded via individual computers, phones and other remote devices, in order for users to combine said photographs with photographs of others and create a visual work of art that can be purchased.

### BACKGROUND OF THE INVENTION

Companies, organizations, and individuals frequently want to raise funds for a variety of purposes. Many have found that it is easier to do so when something is given in exchange, i.e., in the way of an auction or raffle. With the advent of social media and the proliferation of communication via the Internet, it is possible to request donations and provide the donor with something in exchange via online distribution. Moreover, when a cause or special event attracts the attention of a group or demographic, an assumption is made that those comprising said group would be attracted to a donation opportunity that allows the donor to participate actively and do more than simply render payment. Such active participation may take the form of the creation of a collaborative painting or mosaic, similar in form to a collage or mural, that multiple participants may create onsite in a museum or in a common outdoor space.

It is therefore an object of the present invention to introduce a method and a system for soliciting donations online and providing the user with a visual work of artistic value that is the result of a collaborative effort.

### SUMMARY OF THE INVENTION

This invention provides a method and a system [aka application] for computers, mobile phones, and other remote devices, whereby individuals working from remote and unrelated locations and apparatuses will have the ability to upload single, digital photographs of themselves as part of a collaborative effort to create a single, visual mosaic style digital representation of a recognizable subject such as, a celebrity, a place, or an object. In order to participate in the collaborative effort and purchase the resulting work of art, the user is required to make a donation. The subject matter of the completed mosaic is initially a mystery and is not revealed until the last of the donations and uploads required to complete the picture have been assembled.

The procedure for collecting said donation and identifying the donor is an essential part of the method and a system. The primary subject matter covered herein comprises: a collaborative element whereby multiple users can participate via Internet access from remote and unrelated locations and apparatuses; and, a restriction of access to users who make monetary donations.

### BRIEF DESCRIPTION OF THE DRAWINGS

FIG. 1 is a flow chart showing the general process of the present invention.

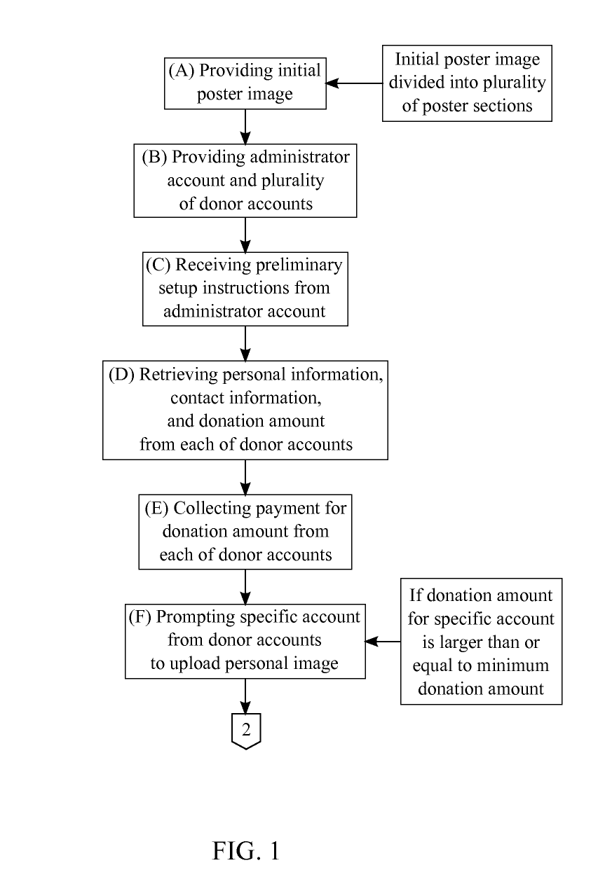

FIG. 2 is a continuation of the flow chart shown in FIG. 1.

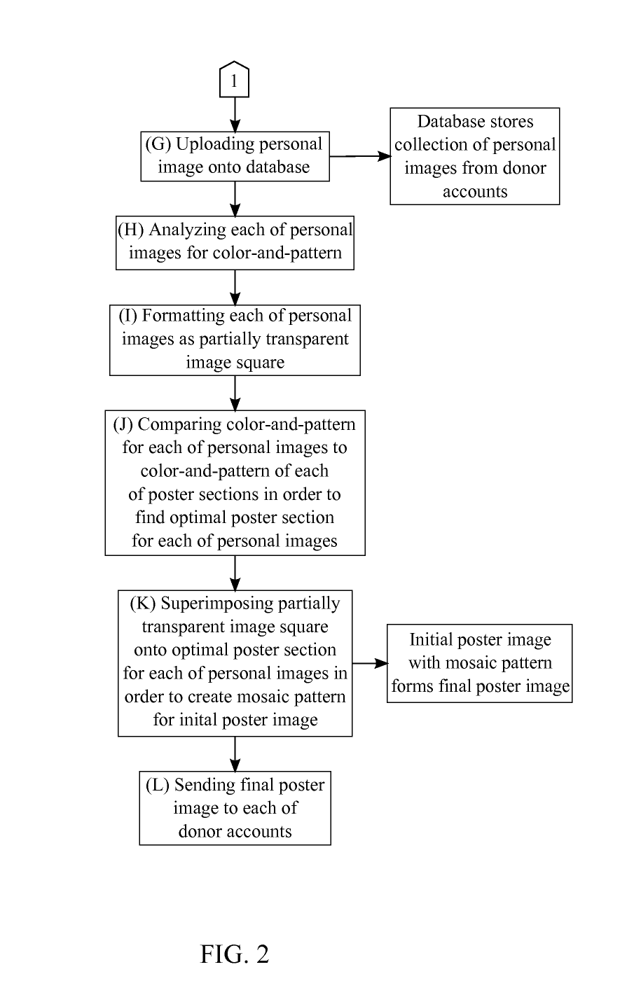

FIG. 3 is a flow chart describing how to set the minimum donation amount for the present invention.

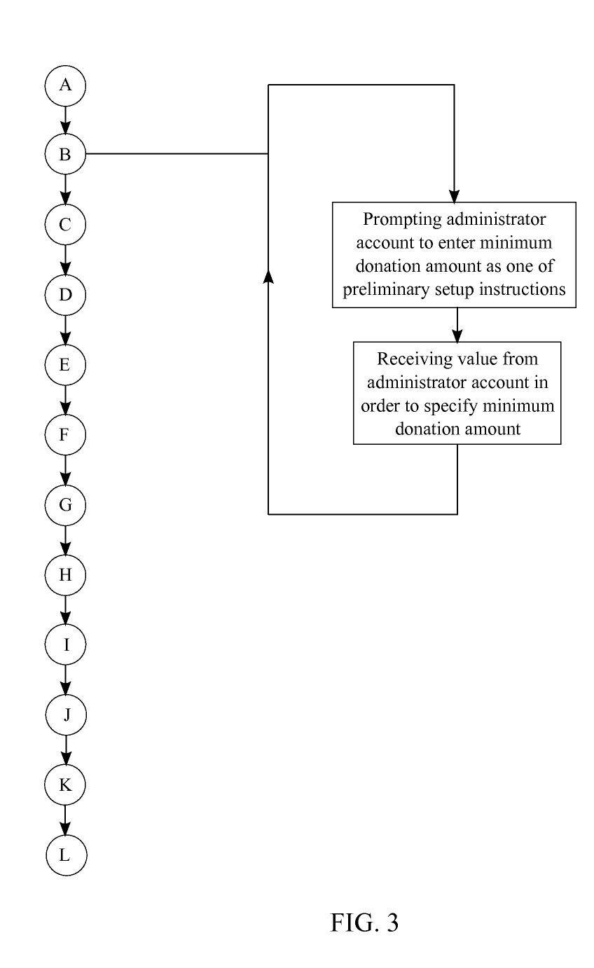

FIG. 4 is a flow chart describing how to set the financial goal for the present invention.

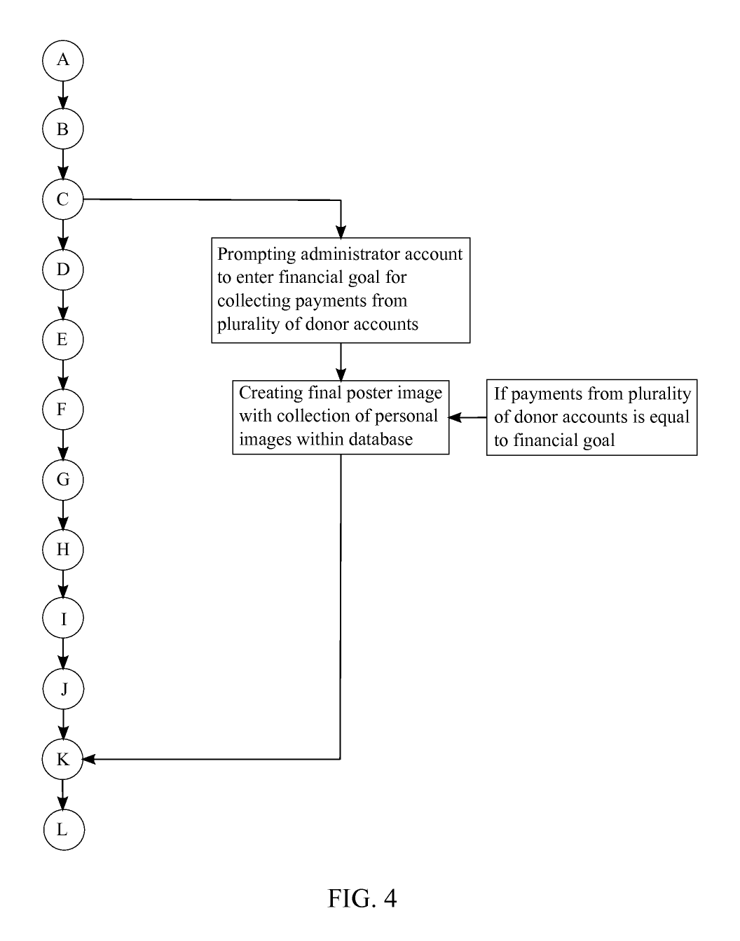

FIG. 5 is a flow chart describing how to send the digital version of the final poster image.

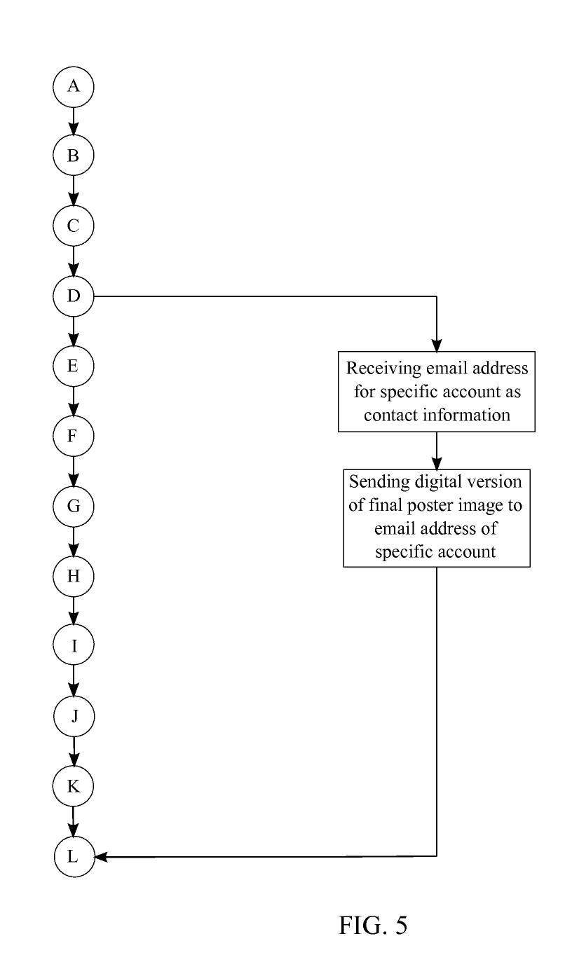

FIG. 6 is a flow chart describing how to send the physical version of the final poster image.

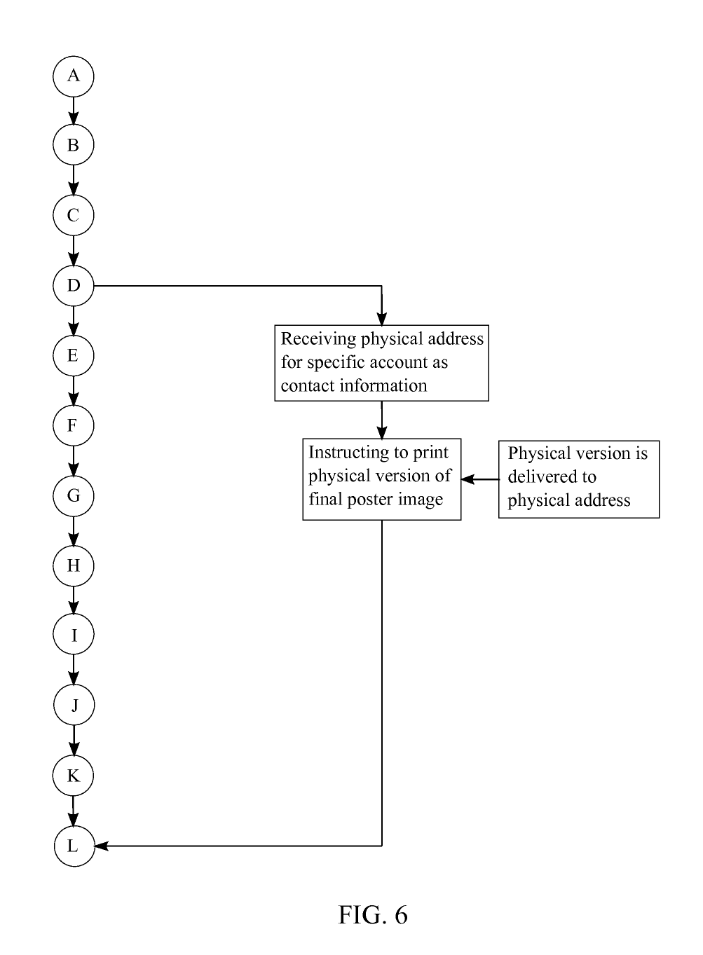

FIG. 7 is a flow chart describing how prizes are awarded to the donor accounts through the present invention.

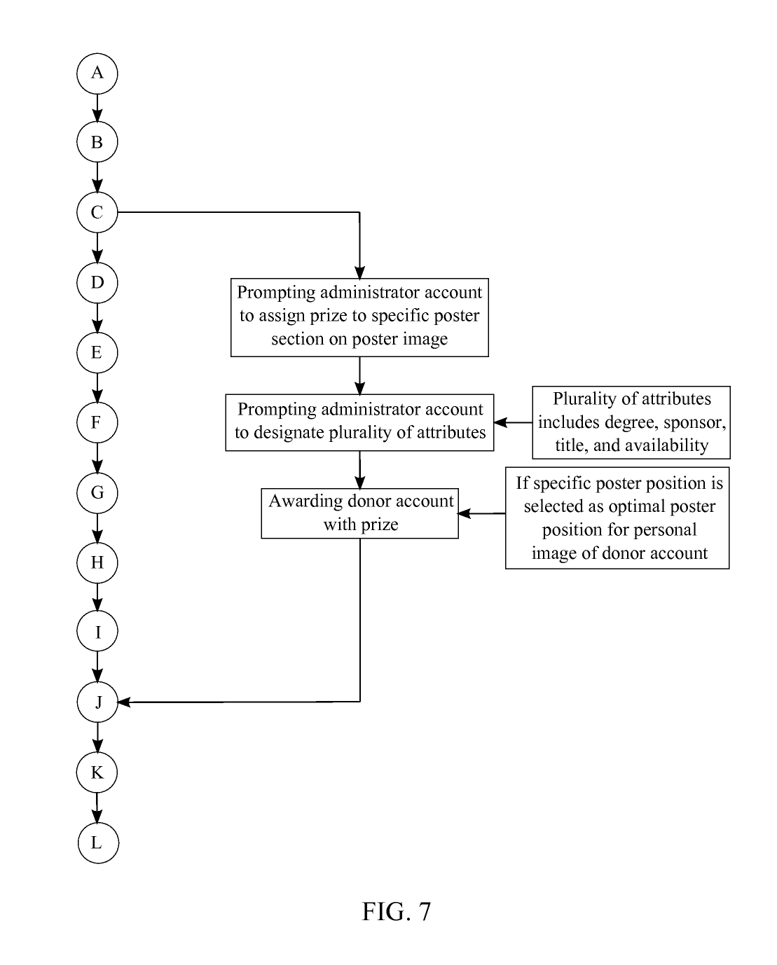

FIG. 8 is a flow chart describing how supplemental persuasion features are shown to the donor accounts through the present invention.

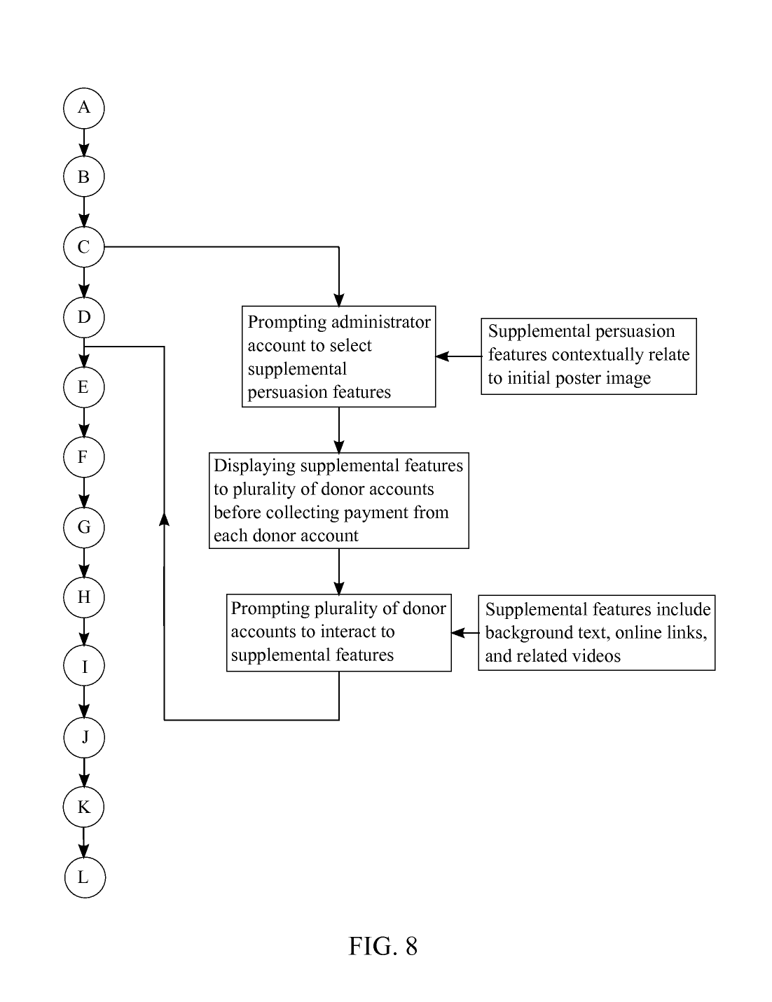

### DETAIL DESCRIPTIONS OF THE INVENTION

All illustrations of the drawings are for the purpose of describing selected versions of the present invention and are not intended to limit the scope of the present invention.

The present invention is a software application for fundraising through a collaborative creation of artwork with prize-winning incentives. The present invention can either be executed on a computer as a website or through a smart-phone as a mobile application. The present invention creates a virtual fundraising event that persuades users to make a financial contribution by prompting them to upload a picture, which will be used later as a part a mosaic pattern for a poster image. The present invention can be applied in a variety of contexts including but not limited to fundraising for charitable causes, marketing of brands and merchandise, the exchange of information, the hosting of contests, and the cataloging of available products and services for sale in multiple industries including but not limited to education, entertainment, environmental and community outreach. The initial poster image should focus around the cause of the virtual fundraising event and is divided into a plurality of poster sections so that every picture from a user can be used in the mosaic pattern. For example, the initial poster image can be divided into poster sections of 2 by 2 pixels or 6 by 6 pixels. In addition, the present invention persuades users to make a financial contribution by allowing users to win prizes based on where their picture is placed on the mosaic pattern. Consequently, the software application can be accessed by two kinds of accounts: a plurality of donor accounts and an administrative account. The plurality of donor accounts allows users to access the front end of the software application, and the administrative account allows a user to access the back end of the software application.

The present invention follows a general process while implementing a virtual fundraising event. The general process begins by receiving preliminary setup instructions from the administrator account in order to initialize the virtual fundraising event. The preliminary setup instructions are conditions and settings that will be implemented throughout the virtual fundraising event. The general process continues by retrieving personal information, contact information, and their donation amount from each of the donor accounts. The personal information is used identify each individual donor account and includes information such as the user's first and last name. The contact information is used to send the final poster image to the user of each donor account and includes information such as an email address and a physical address. The software application will then collect a payment for the donation amount from each of the donor accounts. The software application allows each donor account to pay by any electronics means such as through credit card, through banking information, or through another offsite payment service. The software application will then prompt a specific account from the plurality of donor accounts to upload a personal image, if the donation amount for that donor account is larger than or equal to a minimum donation amount. The software application does this for every donor account that financially contributes a donation amount larger than or equal to the minimum donation amount. The personal image can any photograph or visual that the user wants to display as a part of the mosaic pattern. The personal image of the specific account is uploaded onto a database, which is used to store a collection of personal images from the donor accounts. The database allows each personal image to be readily available for the software application for when the collection of personal images will be compiled into the mosaic pattern. In the preferred embodiment of present invention, the database is a MySQL database and data is transferred by PHP.

In order to form an aesthetically pleasing mosaic pattern, the general process must analyze each personal image so that the software application can place each personal image in its appropriate position on the initial poster image. The software application will analyze each of the personal images within the database for color-and-pattern. The software application will also format each of the personal images as a partially transparent image square so that the final poster image will be an overlaying combination of the initial poster image and the collection of personal images. In the preferred embodiment, the transparency of each image square is set to approximately 40%. The general process continues by comparing the color-and-pattern of each personal image to the color-and-pattern of each poster section in order to find an optimal poster section for each personal image within the database. The optimal poster section is the best aesthetic match for each personal image on the initial poster image. Next, the software application will superimpose the partially transparent image square onto the optimal poster section for each personal image in order to create a mosaic pattern for the initial poster image, which forms a final poster image. Finally, the general process concludes by sending the final poster image to each donor account. The final poster image can be sent either as a digital version to the email address of a specific account or as a physical version to the physical address of the specific account, which means the software application will have to instruct an output device to print the final poster image. The physical version of the final poster image can also be printed on T-shirts, hats, mugs, etc.

The preliminary setup instructions that are provided by the administrator account allow the software application to run efficiently and effectively. First, the software application prompts the administrator account to enter a minimum donation amount as one of the preliminary setup instructions. The minimum donation amount prevents users from donating inappropriately small financial contributions. The software application must receive a value from the administrator account in order to specify the minimum donation amount. In the preferred embodiment of the present invention, the value for the minimum donation amount should be $10.00. Second, the software application prompts the administrator account to enter a financial goal for collecting payments from the plurality of donor accounts during the virtual fundraising event. The financial goal is the total amount of monetary contributions that are made by the plurality of donor accounts before the administrator is financially satisfied with the virtually fundraising event. The software application will create the final poster image with the collection of personal images that are currently in the database if the payments from the plurality of donor accounts are equal to the financial goal. Consequently, the financial goal will help to place the appropriate amount of personal images as a part of the mosaic pattern so that the mosaic pattern does not contain enough personal images or so that the mosaic pattern does not contain too many personal images.

An important secondary process for the present invention allows the software application to award the plurality of donor accounts with prizes for financially contributing the minimum donation amount. The secondary process begins by assigning a prize to a specific poster section on the initial poster image, which occurs with the preliminary setup instructions. The software application will also prompt the administrator account to designate a plurality of attributes for the prize. In the preferred embodiment of the present invention, the plurality of attributes for the prize includes the degree, the sponsor, the title, and the availability of the prize. The software application allows the administrator account to edit the plurality of attributes for the prize if the prize has not been won by any donor account. The secondary process continues by awarding a donor account with the prize if the specific poster position is selected as the optimal poster for the personal image submitted by the donor account. In the preferred embodiment of the present invention, each donor account has an equal opportunity to win the prize if their donation amount is larger or equal to the minimum donation amount. A notification can be sent by the software application to inform the administrator account about which donor account won the prize. In one embodiment of the present invention, this secondary process can be run in parallel with multiple poster sections that each has their own prize. This embodiment of the present invention can be used as a game to win prizes for the plurality of donor accounts. This embodiment could also be used as a mystery or puzzle game, where the plurality of donor accounts does not know what the initial poster image is.

Another important secondary process for the present invention allows the software application to further convince a user to financial contribute to the virtual fundraising event. The secondary process begins by prompting the administrator account to select and add supplemental persuasion features. The supplemental persuasion features and the initial poster image are all contextually related to the virtual fundraising event. The software application will display these supplemental persuasion features before collecting the payment from each donor account as a means to provide more information about the cause for the virtual fundraising event. Finally, the software application will conclude by prompting the plurality of donor accounts to interact with the supplemental persuasion features. The supplemental persuasion features include, but are not limited to, background text, online links, and related videos.

In one embodiment of the present invention, the virtual fundraising event is geared towards a celebrity sponsored cause. Thus, the software application will be catered to a specific celebrity. For example, the initial poster image will be of that specific celebrity. In addition, the supplemental persuasion features will be geared towards the specific celebrity and their cause. One example is a textual biography or an online video with the specific celebrity talking about why their cause is important to financially contribute to. If one configuration of the present invention is financially successful to the specific celebrity, then other celebrities can clone that configuration of the present invention for their own causes.

The software application is also able to interact with different social networking sites in order to share their personal images, their personal videos, or the final poster image. This interaction with social networking site should also solicit participation with the virtual fundraising event.

Although the invention has been explained in relation to its preferred embodiment, it is to be understood that many other possible modifications and variations can be made without departing from the spirit and scope of the invention as hereinafter claimed.

What is claimed is:

1. A method of fundraising through a collaborative creation of artwork with prize-winning incentives by executing computer-executable instructions stored on a non-transitory computer-readable medium, the method comprises the steps of:
providing an initial poster image, wherein said initial poster image is divided into a plurality of poster sections;
providing an administrator account and a plurality of donor accounts;
receiving preliminary setup instructions from said administrator account;
retrieving personal information, contact information, and donation amount from each of said donor accounts;
collecting a payment for said donation amount from each of said donor accounts;
prompting a specific account from said donor accounts to upload a personal image, if said donation amount for said specific account is larger than or equal to a minimum donation amount;
uploading said personal image onto a database, wherein said database stores a collection of personal images from said donor accounts;
analyzing each of said personal images for color-and-pattern;
formatting each of said personal images as a partially transparent image square;
comparing said color-and-pattern for each of said personal images to said color-and-pattern of each of said poster sections in order to find an optimal poster section for each of said personal images;
superimposing said partially transparent image square onto said optimal poster section for each of said personal images in order to create a mosaic pattern for said initial poster image, wherein said initial poster image with said mosaic pattern forms a final poster image; and
sending said final poster image to each of said donor accounts.

2. The method of fundraising through a collaborative creation of artwork with prize-winning incentives by executing computer-executable instructions stored on a non-transitory computer-readable medium, the method as claimed in claim 1 comprises the steps of:
prompting said administrator account to enter said minimum donation amount as one of said preliminary setup instructions; and
receiving a value from said administrator account in order to specify said minimum donation amount.

3. The method of fundraising through a collaborative creation of artwork with prize-winning incentives by executing computer-executable instructions stored on a non-transitory computer-readable medium, the method as claimed in claim 1 comprises the steps of:
prompting said administrator account to enter a financial goal for collecting payments from said plurality of donor accounts; and
creating said final poster image with said collection of personal images within database,
if said payments from said plurality of donor accounts are equal to said financial goal.

4. The method of fundraising through a collaborative creation of artwork with prize-winning incentives by executing computer-executable instructions stored on a non-transitory computer-readable medium, the method as claimed in claim 1 comprises the steps of:
receiving an email address for said specific account as said contact information; and
sending a digital version of said final poster image to said email address of said specific account.

5. The method of fundraising through a collaborative creation of artwork with prize-winning incentives by executing computer-executable instructions stored on a non-transitory computer-readable medium, the method as claimed in claim 1 comprises the steps of:
receiving a physical address for said specific account as said contact information; and
instructing to print a physical version of said final poster image, wherein said physical version is delivered to said physical address.

6. The method of fundraising through a collaborative creation of artwork with prize-winning incentives by executing computer-executable instructions stored on a non-transitory computer-readable medium, the method as claimed in claim 1 comprises the steps of:
prompting said administrator account to assign a prize to a specific poster section on said initial poster image;
prompting said administrator account to designate a plurality of attributes for said prize, wherein said plurality of attributes includes a degree, a sponsor, a title, and an availability; and
awarding a donor account with said prize,
if said specific poster position is selected as said optimal poster position for said personal image of said donor account.

7. The method of fundraising through a collaborative creation of artwork with prize-winning incentives by executing computer-executable instructions stored on a non-transitory computer-readable medium, the method as claimed in claim 1 comprises the steps of:
prompting said administrator account to select and add supplemental persuasion features, wherein said supplemental persuasion features contextually relate to said initial poster image;
displaying supplemental persuasion features to said plurality of donor accounts before collecting said payment from each of said donor accounts; and
prompting said plurality of donor accounts to interact to said supplemental persuasion features, wherein said supplemental persuasion features include background text, online links, and related videos.
